(19) United States
(12) Patent Application Publication
(10) Pub. No.: US 2026/0174081 A1
(43) Pub. Date: Jun. 25, 2026

(54) WEED CONTROL

(71) Applicant: Thatchtec B.V., Wageningen (NL)

(72) Inventors: Herman FEIL, Wageningen (NL); Adrianus Bastiaan REIJTENBAGH, Wageningen (NL); Marco JANSEN, Wageningen (NL)

(21) Appl. No.: 19/124,539

(22) PCT Filed: Nov. 3, 2023
(86) PCT No.: PCT/NL2023/050578

§ 371 Date: Apr. 25, 2025

(30) Foreign Application Priority Data
Nov. 4, 2022 (NL) 2033466

(51) Int. Cl. A01N 43/80; A01N 43/54; A01N 43/56; B09C 1/08

(52) U.S. Cl. CPC A01N 43/80; A01N 43/54; A01N 43/56; B09C 1/08; A01N 2300/00

(57) ABSTRACT

The invention provides a method for weed control, the method comprising a deposition stage and a barrier layer stage subsequent to the deposition stage, wherein: the deposition stage comprises providing a product (10) comprising processed organic material (11) on soil (40), wherein the processed organic material (11) comprises one or more materials selected from the group consisting of proteins, carbohydrates, and lipids, wherein the product (10) comprises at least 25 grams of carbon per 100 grams of product (10) on a dry-matter basis, wherein the soil (40) hosts weeds (30); and leaving the product (10) on the soil (40) without actively mixing the product (10) in the soil (40), wherein the processed organic material (11) comprises one or more materials selected from the group consisting of proteins, carbohydrates, and lipids, and wherein at least 100 grams of carbon per m2 soil (40) is provided by the product (10) on the soil (40); and the barrier layer stage comprises providing an oxygen barrier layer 15 (20) on the soil (40) with the product (10) provided thereon.

### FIELD OF THE INVENTION

The invention relates to a method for weed control.

### BACKGROUND OF THE INVENTION

Weed control methods, excluding the use of chemical pesticides, are known in the art. WO2022019766, for instance describes an assembly for exterminating a plant or weed, in particular an invasive plant or weed, specifically Japanese Knotweed, said assembly comprising: —a cooling device for cooling a coolant, and—a cooling lance, fluidly coupled to said cooling device via at least one flexible conduit, said cooling lance adapted to be inserted into the ground and said flexible conduit allowing said cooling lance to be inserted into said ground at a freely selectable position with respect to said cooling device, said cooling lance further comprising: —a length of 0.5-2 meters; —a tip end for inserting and lowering into the ground—a coupling end opposite said tip and having a coolant inlet and a coolant outlet for said coolant, and—a coolant flow path through said cooling lance and coupling said coolant inlet and said coolant outlet and allowing cooling of at least part of said cooling lance.

CN 108 739 896 A describes an organic preparation to inhibit germination of weeds in farmland soil and a preparation method and application method thereof. The organic preparation comprises organic materials and decomposition-promoting ingredients, wherein the organic material is solid organic materials or liquid organic materials; when the organic materials are solid organic materials, the organic materials include at least one of crop straws and sawdust; when the organic materials are liquid organic materials, the organic materials include at least one of honey and alcohol fermentation broth; the decomposition-promoting ingredients include at least one of a special microbe and organic catalysts. The organic preparation is evenly spread on the surface of the soil to be treated and evenly mixed with the 0-30 cm plow layer soil. The organic preparation can be decomposed by functional microbes in the soil to produce organic acids, such as acetic acid and butyric acid, thereby killing weed seeds through the organic acids.

G. Singh et al. describe in ACS Agric. Sci. Technol. Vol. 2(4) 2022, pp. 769-779, that managing weeds and soil-borne pathogens is one of the most challenging aspects of organic crop production. Anaerobic soil disinfestation (ASD) has been identified as a microbial-driven approach capable of suppressing weed species and soilborne pathogens. The carbon substrate, which is mixed evenly into the soil, is a critical component of ASD that can be optimized to enhance pest control effectiveness. To assess this potential, a microcosm greenhouse study was conducted to determine the differential impact of agro-industrial waste streams as carbon sources, using molasses+mustard meal (MMIM), molasses+chicken manure (MCM), molasses+corn gluten (MCG), and molasses+sweet potatoes (MSP) in anerobic or aerobic soil conditions (covered and not covered with plastic film) on bacterial wilt (caused by Ralstonia solanacearum), weed suppression, soil anaerobic conditions, and tomato (Solanum lycopersicum L.) crop health. Under anaerobic conditions, the carbon sources effectively controlled weeds by 75-96% compared with no carbon source (NCS) and aerobic treatment and greatly reduced or eliminated Ralstonia solanacearum populations from initial 5.6 to final 0 Log₁₀ (CFU+1) g⁻¹ dry soil. No phytotoxic effects were observed in tomato plants transplanted 14 days after ASD treatments. The findings encourage further investigations on the interactions of ASD with soil chemistry and microbial biomass in the context of pest management.

U. Shrestha et. al. describe in Weed Research Vol. 58(5), 2018, pp. 379-388 an ASD method using a dry-molasses based or wheat bran-based organic amendment. They describe in the experimental procedure that an equal amount of sand and soil containing organic amendments was mixed by hand and used to fill 2600 cm³ pots (12 cm diameter, 23 cm height). The posts were covered with polyethylene mulch (0.032 mm) secured with heavy duty rubber bands.

Ram B. Khada et al describe in Crop Protection Vol. 135, 2020, 104846. that soilborne diseases, root-knot nematodes (Meloidogyne spp.), and weeds are the major yield-limiting factors in okra (Abelmoschus esculentus) and eggplant (Solanum melongena) production in Nepal. Anaerobic soil disinfestation (ASD) is a promising technique in developed countries to control soilborne pests, but it has not been tested in many developing countries. Experiments were conducted in the western plain region of Nepal in okra and eggplant from March to July 2016 and October 2016 to April 2017 (eggplant only) to compare locally available carbon sources, mixed into the soil, for efficacy in ASD. They conclude that ASD appears to have great potential in Nepal because of its broad-spectrum impact on multiple soilborne pests and ready availability of inexpensive local inputs.

### SUMMARY OF THE INVENTION

Different methods of anaerobic soil disinfestation (ASD) (also known as biological soil disinfestation) are known in which soil is treated to control plant disease and manage yield decline in many crop production systems. ASD is based on introducing easily compostable material, carbon rich, organic material into the soil and successively covering the soil surface with a plastic film for a period of time, resulting in an anaerobic condition in the soil. The compostable material is normally introduced in the top layer (20-30 cm deep) of the soil. The effect of the method is limited to depth of the material incorporation. To increase the effect liquid materials that may penetrate deeper in the soil are also applied.

Knotweed, especially Asian knotweeds, e.g. Japanese, Sachalin and Bohemian knotweed, as well as Giant hogweed are considered to be one of the most invasive exotic species. It is very difficult to get rid of the plants. The strong growth of the knotweed is one of the reasons that it displaces many native plant species. Further, the invasive root systems and strong stems of these plants may cause damage to buildings, roads, and possible other infrastructures. Different methods are used to (try to) control weed, more especially the knotweed. Methods range from mechanical methods (mowing and removal) and thermal methods to biological methods and chemical methods. The chemical methods appear to be most successful. However, chemicals like glyphosates preferably are not used anymore. Moreover, also these chemical methods may still only partly harm the roots and not eradicate the plants.

Hence, it is an aspect of the invention to provide an alternative method for weed control, which preferably further at least partly obviates one or more of above-described drawbacks. The present invention may have as object to overcome or ameliorate at least one of the disadvantages of the prior art, or to provide a useful alternative.

Hence, in an aspect, the invention provides a method for weed control. The method comprises a deposition stage. The method further comprises a barrier layer stage subsequent to the deposition stage. In embodiments, the deposition stage comprises providing a product on soil and leaving the product on the soil. The soil may especially host weeds. In further specific embodiments (of the deposition stage), the product is (provided and successively) left on the soil without active mixing. In embodiments, the product comprises non-living organic material. The product may especially comprise processed organic material. The processed organic material may for instance be obtained by processing plants, and/or by processing animals and/or by processing parts of plants and/or animals. The processed organic material may in specific embodiments comprise one or more materials selected from the group consisting of proteins, carbohydrates, and lipids. In further specific embodiments, processed organic material comprises carbon. Further, in specific embodiments, at least 100 grams of carbon per m² soil is provided by (providing) the product on the soil. The barrier layer stage comprises providing a barrier layer on the soil (with the product provided thereon). Furthermore, especially the barrier layer comprises, especially is, an oxygen barrier layer. Hence, especially, the product is not actively mixed in the soil prior to providing the oxygen barrier on the soil.

The method of the invention is especially a biological method. The method may not require chemicals or synthetic herbicides to control weed. The method may be a simple, non-complex method. The method especially does not require working or mixing the product into the soil. It has been found that advantageous results for weed control (eradicating weeds) may be obtained in particular from the method that comprises (only) applying, such as sprinkling, the product on the ground (soil) and leaving the product on the ground after the application of a barrier layer between the ground and the air. In embodiments, the barrier layer may be left, for instance, during a period of a month or a couple of months (on the soil). In this period, the weeds may be (substantially) eradicated without further (human) effort. After this period the weeds, especially the roots of the weeds, may have lost their competence to propagate.

Another of the advantages of embodiments of the method is that the product especially has a known and, furthermore, a constant composition. In addition, the product is in embodiments particulate, which may ensure its easy and uniform distribution on the soil. A further advantage of the method of the invention is that the product is especially made up of biological/organic material. Further, the method is especially based on biological or organic processes that may be controlled by providing the product on the soil and successively (only) covering the soil (having the product deposited on in) to reduce or minimize an oxygen transfer from the air to the soil (comprising at least parts of the weed).

Hence, the invention provides, in specific embodiments, a method for weed control, the method comprising a deposition stage and a barrier layer stage, subsequent to the deposition stage, wherein: the deposition stage comprises providing a product comprising processed organic material on soil, wherein the soil hosts weeds, and leaving the product, (especially without active mixing) on the soil, wherein the organic material comprises one or more materials selected from the group consisting of proteins, carbohydrates, and lipids, and wherein especially at least 100 grams of carbon per m² soil is provided by (providing) the product on the spoil; and the barrier layer stage comprises providing an oxygen barrier layer on the soil with the product provided thereon. In embodiments, the deposition stage comprises leaving the product on the soil, wherein the product is product is not actively mixed in the soil. Especially, the product is not actively mixed in the soil prior to (and after) providing the oxygen barrier on the soil.

The method relates to weed control, especially for controlling weeds growing in the soil. The terms “weed control”, “control of weeds”, and comparable terms especially refer to removing, especially eradicating (at least part of) weeds. The soil (at the start of the deposition stage) especially comprises at least part, such as the roots, of weeds. The soil especially hosts at least parts of the weeds (at the start of the method). Herein, the term “weeds” is used. The term may refer to a single type of weed as well as a plurality of different types of weed. Further, especially, the plural form “weeds” is used to indicate that normally the method is used to control a plurality of weeds and/or a plurality of weed plants. It will be understood that the method may also be applied to a single weed (plant). Hence, the term “weeds” may in embodiments cover a single weed.

The barrier layer especially comprises, even more especially is, an oxygen barrier layer. The barrier layer may hinder or slow down a possible transfer of oxygen from the air to the soil (comprising the weeds) during a period that the barrier layer is left on the soil (with the product deposited on it). Such period (wherein the barrier layer is left on the soil) may herein also be referred to as “holding period” or “holding time”. The holding period may essentially be indefinitely long. For practical reasons, the holding period is in embodiments ultimately 24 months, such as ultimately 12 months, especially ultimately 6 months, see further below.

The term “processed organic material” is used herein to refer to organic material, such as plant material and animal material, that is processed and/or has been subjected to a process (or controlled) treatment. Organic materials like fresh grass, straw, leaves, etc. that are not processed, or only reduced in size and/or dried by the influence of weather, are not covered by the term “processed organic material”. On the other hand, the term covers organic material obtained by processing plants, animals, or parts thereof (especially where processing entails more than mere cutting or size reduction). For example, proteins, lipids, and carbohydrates that have been isolated are covered by the term. Further, processed organic material may, e.g., comprise organic material that is cut and/or mown and successively (further) processed (in a controlled way). For instance, (aerial) parts of plants may be cut (from their roots), and these parts may be (further) processed. Further, the terms “processing” and “further processing” and comparable terms, especially refer to performing a (mechanical, physical, and/or chemical) action or process (treatment) in a controlled way. For instance, the organic material may be dried in a controlled (drying) process. The terms “controlled way”, “controlled process” and the like will be understood by the skilled person and refer to controlling (the) relevant process parameters or conditions of the specific process (i.e. parameters that are relevant for obtaining one or more predetermined product characteristics). The term “controlled way” in relation to a treatment or process may especially indicate that the treatment or process may be reproduced, the treatment or process is especially a reproducible treatment or process. Drying in a controlled way refers for instance to drying at a controlled temperature and duration (or according to a certain time/temperature trajectory). Furthermore, during drying especially a humidity of the air or any other drying atmosphere surrounding the material to be dried may (also) be controlled. Leaving grass or stalks on the land and successively drying it by sun in the open air (e.g. resulting in hay or straw) typically is not (a) controlled (treatment). Moreover, herein such ways of handling may also not be referred to as a “process”. The such-obtained (by an uncontrolled way) material may also not be referred to herein as “processed organic material”.

The term “processing” may especially relate to a method of preparing, changing, or treating food (material) or natural substances as a part of an industrial (or semi-industrial) operation. The term “processed organic material” may in embodiments refer to (organic) material obtained from an industrial (or semi-industrials) (mechanical, physical and/or chemical) operation on food (or feed ingredients) and/or natural substances. The term “industrial operation” indicates that the operation is performed in a controlled and reproducible way. An industrial operation may further especially be performed on a larger scale than artisanal operations.

The term “non-living organic material” is used herein to denote an organic material that is not in the form of unprocessed plants, plant residues, animals, or animal residues. The term “unprocessed” herein, especially means not processed (in a controlled way) or only subjected to mechanically handling that consists of cutting, such as mowing or chopping. Organic materials like fresh (or untreated or not treated by a controlled method but, e.g., only reduced in size and/or dried by the sun and wind on the land) grass, straw, leaves, etc. are (also) not covered by the term “non-living organic material”.

The processed organic material may in embodiments comprise a by-product or rest product from a food or feed processing operation (wherein the rest product is optionally further processed). Further processing may e.g. comprise extraction, isolation, separation etc. Additionally, or alternatively, in embodiments, the processed organic material may comprise a by-product from farming or from an agricultural operation that is further processed.

The processed organic material may in embodiments comprise or be based on an agricultural by-product. In embodiments, e.g., the agricultural by-product may comprise stems with leaves optionally including roots of vegetable plants, such as “waste” or “remainders” after harvesting (fruits and/or leaves)(of the vegetable plant). These stems may be dried at a (controlled) temperature of at least 30° C. for a period long enough to reduce the moisture content in the stems to below 20 wt %, especially below 15 wt %, such as below 10 wt %. The dried stems may further be chopped. The product may in embodiments comprise such (especially chopped) dried tomato plant stems. In further embodiments, the product may comprise (harvested) duckweeds (or “Lemnoideae”). The duckweed may be (further) processed, such as be dried in a controlled way (such as at a controlled temperature to e.g. a predetermined moisture content). Duckweed may in embodiments be advantageously applied for its high protein content. The product may (also) comprise a by-product (or “biomass”, see also below) obtained from processing duckweed. Vegetable material (leaves, duckweed, etc.) may e.g. be processed for obtaining or isolating valuable components from it, especially leaving biomass as a by-product. In embodiments, the product comprises the biomass. Additionally, or alternatively, the biomass may be further processed, and the product may comprise (elements) of the further processed biomass.

Therefore, herein especially the term “processed organic material” is used when referring to the product or at least the relevant (active) part of the product. The processed organic material may also be referred to as the active ingredient of the product. The term “organic material” in relation to the process (or the product) especially refers to the processed organic material.

In embodiments, the product is substantially completely made up of the processed organic material (and especially of the active ingredient). Yet, in further embodiments a further ingredient, e.g. a (inorganic) binder or an excipient, is part of the product. The terms “binder” and “excipient” herein especially refer to non-active compounds, especially not being a carbohydrate, lipid, or protein. Carbohydrates, lipids, and proteins may in embodiments be used as binder in the product. Said materials are then especially also referred to as active ingredients and therefore may be considered as part of the processed organic material. The product especially comprises processed organic material.

The processed organic material may especially comprise a material obtained by processing (of) plants or parts thereof (or “plant material”). Additionally or alternatively, the processed organic material comprises a material obtained by processing (of) animals or parts thereof (or “animal material”). Hence, in specific embodiments, the processed organic material comprises a material obtained by processing (i) plants (plant material), (ii) animals (animal material), or (iii) parts thereof.

In further specific embodiments, the material (obtained by processing) comprises a by-product of an industrial process, e.g., a side stream from plant processing. The material, especially the by-product, may comprise biomass. Additionally or alternatively, the material (obtained by processing) comprises a (further) processed material of an agricultural operation.

In further embodiments, the processed organic material comprises one or more of (i) a by-product (originating) from an industrial process for processing organic material and (ii) a (further) processed organic material originating from of an agricultural operation.

In embodiments, organic materials such as isolated gluten are also covered by the term “processed organic material”. In another embodiment, the term also covers organic materials chosen from a group comprising humus, compost, extracted soya bean meal, bone meal, gelatin, and optionally granulated manure. The product may in embodiments comprise pea meal. In further embodiments, the product comprise maize flour (or maize meal). The processed organic material may in embodiments comprise non-living organic material. In specific embodiments, the non-living organic material is non-living biomass.

Especially, the method relates to weed control of invasive weeds. Examples of invasive weeds are for instance, Himalayan balsam, Buddleia Davidii, Giant hogweed, bamboo, and different types of knotweeds. The method especially relates to weed control of Asian knotweed and other invasive weeds (described herein), e.g. Giant hogweed (Heracleum mantegazzianum). The Asian knotweed may e.g. comprise one or more knotweeds selected from the group consisting of Japanese knotweed (Fallopia japonica) Sachalin knotweed (Fallopia sachalinensis) and Bohemian knotweed (Fallopia bohemica).

In embodiments, the weeds comprise one or more of Giant hogweed and Asian knotweed. The soil especially comprises (at least parts of) the weeds (before providing the product on the soil).

In an advantageous embodiment according to the present invention, the method involves the provision of the product on the soil, where the product comprises a material (especially one or more materials) chosen from a group of proteins, carbohydrates and lipids and especially does not contain any unprocessed fresh plants or unprocessed fresh plant residues; followed by the application of a barrier layer between the soil and the air. Further, in embodiments, the product comprises one or more of the various types of powders, granulates, liquids and agricultural by-products described below. Further, the method especially relates to weed control based on imposing an anaerobic condition to the soil (comprising the weed).

The term “anaerobic condition” especially relates to a condition wherein an amount of oxygen in a gaseous material comprised by the soil (especially in the pores and/or between soil particles) is lower than an amount of oxygen in air. Especially, said amount of oxygen in the gaseous material comprised by the soil is less than 5 vol %, especially less than 2 vol %, such as less or equal to 1 vol %, especially at most 0.5 vol %.

The term “unprocessed fresh plants or unprocessed fresh plant residues” denotes fresh plants or plant residues that have not been subjected to any treatment other than optional cutting and/or size reduction—such as mowed grass—and/or being dried by the sun and the wind by merely leaving it on the land for a period. The (further) processing of plants or plant residues can lead for example to products such as extracted rapeseed meal, extracted soya bean meal, gluten, steamed potato peelings and Protamylasse.

The term “agricultural by-product” is used here to denote materials formed in farming and containing proteins and/or carbohydrates and/or lipids, an example being slaughter waste. Other examples of agricultural by-products are extracted soya bean meal, steamed potato peelings and bone meal. A further example of agricultural by-products are stems with leaves optionally including roots from agricultural or horticultural plants after harvesting. The agricultural by-product may be a side stream resulting when processing agricultural produce or products, and as such may be referred to as a processed organic material. The agricultural by-product may comprise a by-product or rest product from a food or feed processing operation. The agricultural by-product may also be (further) processed, resulting in the processed organic material. The term “agricultural operation” especially refers to a farming operation.

The product especially comprises a material chosen from a group comprising proteins, carbohydrates and lipids and may be non-living biomass. In embodiments, the processed organic material comprises one or more materials selected from the group consisting of proteins, carbohydrates, and lipids.

In embodiments, the product contains at least 10 wt % of protein on a dry-matter basis. In embodiments, the product comprises at least 15 wt % protein (on a dry-matter basis). In further embodiments, the product comprise at least 5 wt % of protein calculated on a dry-matter basis. Especially, the product comprises an amount of protein selected from the range of 5 wt %-40 wt %, especially from the range of 15-40 wt %, such as 20-35 wt %. In specific further embodiments, the product comprises at least 5 wt % of protein, such as at least 10 wt % of protein, calculated on a dry-matter basis. The product may in embodiments comprise no more than 40 wt % protein, such as no more than 35 wt % protein.

Further, the product, especially the processed organic material, essentially comprises carbon (i.e. carbon atoms as being part of molecules in the organic material). The product may in embodiments comprise at least 10 grams of carbon per 100 grams of product (on a dry-matter basis). The product may especially comprise at least 25 grams of carbon, such as at least 30 grams, especially at least 40 grams, such as at least 50 grams of carbon per 100 grams of product. In embodiments, the product comprises no more than 75 grams of carbon, especially no more than 60 grams of carbon, such as a maximum of 50 grams of carbon, (all) per 100 grams of product. In specific embodiments, the product comprises at least 25 gram of carbon per 100 gram of product, especially at least 30 gram of carbon per 100 gram of product, calculated on a dry-matter basis. In further specific embodiments, the product comprises a maximum of 40 wt % per 100 gram of product, especially a maximum of 35 wt % of carbon per 100 gram of product (on a dry-matter basis).

In embodiments, the product comprises at least 10 grams of carbon per 100 grams of product. In specific embodiments, the product comprises 10-50 wt % of carbon on a dry matter basis. The product especially comprises 20-40 wt % carbon on a dry matter basis. On average, products made up of protein, lipid and carbohydrate may comprise 25-35 wt % carbon.

In specific embodiments, the product may (further) comprise biochar. Biochar is a (residual) product obtained by pyrolysis of organic material, especially a carbon containing product, such as wood or biomass. Pyrolysis is a controlled process in which the organic material is thermally decomposed in the absence of oxygen. Biochar may also be referred to as “activated carbon”. Biochar especially consists of substantially only carbon. In embodiments, the product may comprise at least 90 wt % carbon, such as at least 95 wt % carbon, on a dry-matter basis. Carbon may in embodiments be present in the form of biochar. Additionally, or alternatively, carbon may be present in the product in the form of atomic carbon (e.g. in protein and/or lipid and/or carbohydrate).

Herein, weight percentages especially relate to weight percentage on a dry-matter basis, unless otherwise indicated in the description or unless it will be clear to the skilled person that another basis is meant. The terms “dry-matter basis”, “dry-matter weight”, and “dry-matter” are known by the skilled person. The terms “dry-matter” and “dry-matter basis” such as in “calculated on a dry-matter basis” and “relative to a dry matter weight” relate to a total weight of a product (comprising a determined weight of water) minus the weight of water in the product (the determined weight of water), i.e. the weight of the dry-matter. The dry matter weight of a product is especially equal to a total weight of the product after removing substantially all of the water from the product, such as by heating (over 100° C.) of the product (especially over an extended period of time). Weight percentages calculated on a dry-matter basis are based on the percentages in the dry-matter. For instance, if a component in a product has a (dry) weight of x grams and a total dry-matter weight of the product is 100 gram, then the weight % of the component equal x (weight) % (calculated) on dry-matter basis.

In a further embodiment, the method comprises applying, such as sprinkling, the particulate organic product on the soil, followed by the application of a barrier layer between the soil and the air.

The term “particulate organic material” is used here to denote a particulate product, essentially consisting of particles defined below (such as powders and/or granulates). The particles may especially contain one or more organic components preferably chosen from a group comprising proteins, carbohydrates, and lipids. The product may comprise particulate processed organic material. In specific embodiments, the product comprises a particulate product. The product may in further embodiments comprise a fiber.

In a further embodiment, the product is therefore in the particulate form. The particles of the product may have a d_{3,2} value of about 0.5 μm-10 mm, especially about 1 μm-5 mm, and more especially about 0.1-5 mm. The d_{3,2} value of a particle is defined as the volume/surface area mean surface or Sauter mean diameter.

Herein, the term “product” may especially relate to “the product to be provided on (to) the soil”. If the product is provided on the soil, characteristics of the product may change; a granular product may, e.g., fall apart or dissolve and potentially form a liquid, et cetera.

Powder is a particulate product whose particles can range from very small (for example of the order of magnitude of about 0.5-100 m) to quite large (for example of the order of magnitude of about 0.1-1 mm). In the case of a granulate, the particle size can vary for example from about 1 to 10 mm. According to one of the advantageous embodiments, the product is a granulate. According to another advantageous embodiment, the product is a powder. The product may (also) comprise a granulate and also a powder. The product may especially comprise a low moisture content. In embodiments, the moisture content is equal to or less than 15 wt %, especially equal to or less than 12 wt %, such as equal to or less than 10 wt %. Especially, the dry-matter weight of the product may in embodiments comprise about 85-95%, especially 90-95%, of a weight of the product including the (weight of the) moisture.

In further specific embodiments, the product comprises a liquid. The term “liquid” is used here to denote a pourable substance comprising one or more components. The person skilled in the art will realize that a liquid can be for example an emulsion, dispersion, solution, aqueous slurry, suspension and the like. An example of the liquids that can be used in the method is milk, such as cow's, calfs, goat's milk, etc. In an embodiment, the liquid or slurry preferably comprises at least 10 wt % of proteins, calculated on a dry-matter basis. In a further embodiment, the liquid or slurry comprises at least 10 wt % of protein and/or at most 90 wt % of carbohydrates and/or at most 90 wt % of lipids, on a dry-matter basis, totaling 100 wt %. In one of the embodiments, the liquid or slurry comprises at least 1 wt % of carbohydrates, and/or 1 wt % of lipids on a dry-matter basis and/or a remainder consisting of proteins and optionally some inorganic materials, totaling 100 wt % on the dry-matter. If the liquid or slurry comprises a protein in combination with a carbohydrate and/or a lipid, then the total amount of the carbohydrate and the lipids in wt % is in embodiments less than the amount of protein in wt %. In further embodiments, only a part of the product comprises protein and/or carbohydrate and/or lipids (especially herein indicated as active ingredient) and a remainder may not be regarded as active ingredient. Hence, in embodiments, the wt % of protein plus the wt % of carbohydrates plus the wt % of lipids, on a dry-matter basis, of the active ingredients may total 100 wt %. The sum of the wt % protein, the wt % of carbohydrates, and the wt % of lipids, on a dry-matter basis, of the product may also be lower than 100 wt %, e.g. at least 75 wt %, such as at least 90 wt %, especially at least 95 wt %, even more especially at least 97 wt %. The product may e.g. comprise an inorganic compound.

In a further embodiment, the product comprises a slurry, such as for example an aqueous slurry of one or more of the following substances: wheat gluten, thick potato sap, Protamylasse, wheat yeast concentrate, and liquid and/or solid by-products of bio-ethanol production.

The product—notably the product comprising processed organic material (especially non-living organic material), the product comprising no unprocessed fresh plants or unprocessed fresh plant parts, the particulate organic product, or the particulate protein-containing product—may especially comprise one or more organic components (materials) chosen from a group consisting of a protein, a carbohydrate and a lipid (where the particulate protein-containing product comprises a protein by definition), for example a combination (mixture) of (different) proteins or a combination (mixture) of (different) proteins and binders and/or fibers, or combinations of one or more proteins, carbohydrates and inorganic substances.

In embodiments of the product comprising a protein in combination with a carbohydrate and/or a lipid, the total amount of carbohydrate in wt % may be less than the amount of protein in wt %. Especially said total amount of carbohydrate may in embodiments be less than half the amount of protein in wt %. In other embodiments, the amount of protein in wt % may be less than the amount of carbohydrates and/or the lipids in wt % in the product. In further embodiments, the product comprises an amount of lipid selected from the range of 2-15 wt %, such as in the range of 2-8 wt %, especially 4-5 wt %, or in the range of 7-15 wt %, such as 8-12 wt %, especially 9-11 wt % (all on a dry-matter basis).

Alternatively or additionally, the product may in embodiments comprise a carbohydrate, such as a sugar or a starch. Especially, an amount of carbohydrate in the product may be selected from the range of 1-40 wt %, such as selected from the range of 1-15 wt %, especially 3-15 wt %, such as 3-12 wt %, especially 5-12 wt %, even more especially 6-9 wt % (on a dry-mater basis). The carbohydrate may be a rapidly degradable carbohydrate, see further below. In further embodiments, the product comprises an amount of starch selected from the range of 1-5 wt %, especially 2-3 wt % (on a dry-matter basis). In yet further embodiments, the product comprises an amount of sugar selected from the range of 2-10 wt %, especially 3-8 wt %, even more especially 4-6 wt % (on a dry-matter basis).

Hence, in embodiments the product comprises an amount of protein selected from the range of 15-40 wt %, especially from the range of 20-35 wt %, an amount of lipid selected from the range of 2-15 wt %, especially from the range of 4-11 wt %, an amount of sugar selected from the range of 2-10 wt %, especially from the range of 4-6 wt %, and an amount of starch selected from the range of 1-5 wt %, especially from the range of 2-3 wt %.

In further embodiments, the product comprises one or more of (i) an amount of protein selected from the range of 5-40 wt %, especially from the range of 15-40 wt %, such as from the range of 25-40 wt %, (ii) an amount of lipid selected from the range of 2-15 wt %, such as from the range of 2-8 wt %, especially selected from the range of 3-7 wt %, even more especially from the range of 4-5 wt %, and (iii) an amount of (a rapidly degradable) carbohydrate selected from the range of 1-15 wt %, especially 3-15 wt %, such as 3-12 wt %, especially 5-12 wt %, even more especially from the range of 6-9 wt % (with all wt % calculated on a dry-mater basis). In alternative embodiments, the amount of carbohydrates in the product may be in the range of 60-80 wt % (on the dry-mater basis).

In specific further embodiments (of the product), the amount of protein is selected from the range of 25-40 wt %, especially 30-35 wt % and the amount of lipid is selected from the range of 3-7 wt %, especially 4-5 wt %, and especially the amounts of sugar and starch are selected from the ranges described above (with all wt % on the dry-matter basis).

In another specific embodiment (of the product), the amount of protein is selected from the range of 15-30 wt %, especially 20-26 wt % and the amount of lipid is selected from the range of 5-15 wt %, especially 9-11 wt %, and especially the amounts of sugar and starch are selected from the ranges described above.

The term “lipid” may relate to a “fat” as well as an “oil”.

In further embodiments, the product contains a small amount of carbohydrates (optionally next to other components), especially rapidly degradable carbohydrates, such as carbohydrates (sugars) comprising monosaccharides and/or polysaccharides with α1→4 linkages. The product may in embodiments comprise at most 30 wt % and especially at most 20 wt %, such as at most 10 wt % of rapidly degradable carbohydrates (sugars), calculated on a dry-matter basis. Higher amounts may in embodiments quickly acidify the soil, inhibiting the process of weed control.

Herein, the terms “a protein” and “proteins” especially relate to a plurality of (different) proteins. Likewise the terms “a carbohydrate” and “carbohydrates”, “a sugar” and “sugars”, “a starch” and “starches” especially relate to a plurality of (different) carbohydrates, sugars, and starches, respectively, and the terms “a lipid” and “lipids” especially relate to more than one (different) lipid.

Suitable proteins are exemplified by potato protein, Protamylasse, bone meal gluten and corn/maize protein. Gluten forms a specific group of proteins, occurring in some seeds and grains. According to an embodiment, the product comprises the particulate or liquid protein-containing product, gluten, and—according to a further embodiment—the product preferably comprises a particulate or liquid protein-containing product selected from wheat gluten, maize gluten, and a combination thereof.

The product may further comprise other proteins, such as for example potato protein, soya bean protein, bone meal or a combination thereof. Especially, the product comprises a combination of gluten(s), such as for example wheat gluten, maize gluten, or a combination thereof, and other proteins, such as for example potato protein, soya bean protein, maize flour, pea meal, bone meal or a combination thereof. The protein may in further embodiments comprise a plant protein. In embodiments, the protein (or product) comprises a leaf protein. The protein (product) may especially comprise rubisco (ribulose-1,5-bifosfaat carboxylase oxygenase).

In a further embodiment, the product comprises especially a particulate or liquid product in the form of one or more proteins, with preferably at least about 10 wt % of protein (on a dry-matter basis), for example comprising 10-30 wt % of protein or especially 15-40 wt % of protein.

According to one of the advantageous embodiments of the present invention, the product is therefore a protein-containing, preferably particulate or liquid, product. The term “protein-containing particulate or liquid product” denotes here a product that both comprises protein and is particulate, such as for example a powder or a granulate, or it is a liquid, such as for example an aqueous slurry.

The protein present in embodiments comprises one or more proteins selected from a group consisting of potato protein, wheat protein, a maize (corn) protein and microbial protein.

A suitable form of protein-containing processed organic material is wheat gluten. Yet another suitable form of protein-containing processed organic material is a product that contains microbial protein. The term “microbial protein” denotes a protein that is obtained from fermentation processes. An example of products containing microbial proteins is wheat yeast concentrate, which is obtained from the fermentation of wheat. Microbial protein can also be formed in the fermentation of for example maize, etc. One can therefore use for example wheat yeast concentrate and/or maize yeast concentrate as the protein-containing processed organic material.

The product may further comprise a fiber. In embodiments, an amount of fiber in the product is at least 5 wt %, such as equal to or more than 10 wt %. Especially, the amount of fiber is equal to or less than 60 wt %, such as equal to or less than 40 wt %, especially equal to or less than 20 wt %. The term “a fiber” may also relate to more than one (different) fiber.

Especially, the product (further) comprises a low mineral content and a low moisture content. The product may e.g. comprise less than 7.5 wt % ash, especially equal to or less than 5 wt % ash. In embodiments, the product comprises at least 2 wt % ash, such as at least 4 wt % ash (on a dry-matter basis).

The processed organic material comprises in further embodiments at least 35 wt %, such as at least 50 wt %, in embodiments at least 75 wt %, rapidly degradable (organic) material. The rapidly degradable material may break down (especially into natural elements, carbon dioxide, and water vapor) by bacteria and other living organisms in and on top of the soil life in 6 months. The remaining part of the processed organic material may degrade slower and may e.g. comprise cellulose or lignin. The terms “rapidly degradable (organic) material” and “rapidly degradable carbohydrates” may in embodiments be used interchangeably. The term “rapidly degradable material” may relate to organic material which may for at least 90 wt % be degraded by micro-organisms in the soil (under standard conditions—especially at 20° C. and 10%-25% humidity) within 3 months. Cellulose and lignin are especially not rapidly degradable materials. Other examples of non-rapidly degradable materials are chitin and keratin.

The product is especially provided on (to) the ground, such as by sprinkling on the ground. It has surprisingly been found that it may not be required to actively mix the product with the soil. The method may especially rule out the need to (actively) introduce the product in the soil, such as by harrowing, ploughing, or injecting. It is assumed that the fermentation of the product on top of the soil reduces the oxygen content in the soil. Furthermore, degradation products like hydrogen sulfide, ammonia and fatty acids may be formed and may migrate into the soil in time. It is hypothesized that based on the anaerobic condition and the presence of the degradation products weeds, especially roots of the weeds, may disintegrate and the weeds may be eradicated in the barrier layer stage. Hence, after providing the product on the soil (ground), the product is especially in contact with a surface of the soil. The soil may further comprise (aerial parts of the) weeds extending from the soil. Before applying the barrier layer on the soil, the product is especially in contact with the open surrounding (environment), especially air (and further with the ground and/or weeds extending from the ground). The product is especially not actively provided in (a top layer of) (such as mixed with) the soil at that stage (unless it is e.g. mixed during sprinkling because of a non-intended movement of material of the top layer of the soil). The product is especially deposited on the soil (ground) in the deposition stage. The term “on” in relation with “provided on the soil”, “provided on the ground” especially may be exchanged with “at”, “on to”, or “on top of”. Further, the term “ground” herein may especially refer to a (top) surface of the soil. It may therefore be explained that the product is provided on the soil as well as that the product is provided on the ground. The soil may have a volume. The term “soil” especially refers to a layer of the earth The soil may especially host parts of the weeds, such as the roots of the weed. Other parts of the weeds may extend from the ground (as well as from the soil). If reference is made to a surface in relation to soil, then this especially relates to the (top) surface of the soil (or to the “ground”).

Herein the term “eradicate” in relation to the weed (control) is used. This term not necessary implies that the weed is completely dead. The weed may still live, but especially has lost its capability to propagate (via the roots) for at least a prolonged time. The prolonged time is especially at least 6 months, such as 1 year, especially a least 2 years. In specific embodiments, the weed does not live anymore after the treatment, or at least lost its capability to propagate permanently.

In embodiments, at least 100 grams, such as at least 200 grams, especially at least 250 grams, of processed organic material is provided per m² on the soil (in the deposition stage). In further embodiments, at least 300 grams, such as at least 400 grams, especially at least 500 grams of processed organic material is provided per m² on the soil (in the deposition stage). In embodiments, equal to or less than 10 kg, especially equal to or less than 5 kg, more especially at equal to or less than 2500 grams, such as no more than 1000 grams, of processed organic material is provided per m² on the soil (in the deposition stage). Higher amounts of processed organic materials may in embodiments be provided. In embodiments, it appeared that about 500 grams of processed organic material (substantially consisting of a mixture of proteins, carbohydrates, and lipids) per m² did effectively control weed.

In embodiments, the amount of processed organic material provided on the soil in the deposition stage is selected from the range of 100-1000 gram per m² soil (ground or surface of the soil), especially from the range of 250-750 gram per m² soil (ground or surface of the soil), such as 400-600 gram per m² soil. In further embodiments, at least 500 gram of processed organic material, especially comprising at least 35 wt %, especially at least 50 wt %, such as at least 75 wt %, rapidly degradable material is provided on the soil in the deposition stage. In specific embodiments at least 250 gram of rapidly degradable organic material is provided per m² on the soil (in the deposition stage). In further embodiments, at least 500 gram of rapidly degradable organic material is provided per m² on the soil. Further, especially equal to or less than 7.5 kg, more especially equal to or less than 5 kg, such as equal to or less than 2500 grams or no more than 1000 grams, of rapidly degradable organic material is provided per m² on the soil (in the deposition stage). Moreover, when applying a product comprising at least 75 wt % (such as at least 85 wt %, especially at least 90 wt %) of rapidly degradable organic material (or rapidly degradable carbohydrates) (in the deposition stage), 250 gram of product per m² may be enough for obtaining the desired result. In embodiments, the product comprises at least 75 wt % rapidly degradable organic material, such as at least 85 wt % rapidly degradable organic material, and especially at least 250 grams of the product is provided on the soil per m² (of soil) (in the deposition stage).

The product especially provides the processed organic material in an amount as described above on the soil. In embodiments the amount may be higher, such as more than 2 kg product per m² soil, or at least 2.5 kg per m² soil, or up to 5 kg product per m² soil, or even more. These high amounts may not be required and lower amounts such as described herein may be sufficient to eradicate the weed. In embodiments, the deposition stage comprises providing the product on the soil, wherein the product provides the processed organic material in an amount of 250-750 gram, such as 400-600 gram, especially at least 500 gram per m² on the soil.

In further embodiments, at least 50 grams, especially at least 100 grams, such as at least 150 grams of protein is provided per m² on the soil (in the deposition stage). Further, especially the amount of protein provided on the soil is especially equal to or less than 750 grams, such as equal to or less than 500 grams, in embodiments equal to or less than 250 grams, per m² soil. In further embodiments, the deposition stage comprises providing the product on the soil, wherein the product provides 100-500 gram, especially at least 150 gram of protein per m² on the soil.

In further embodiments, the deposition stage comprises providing the product on the soil, wherein the product provides 50-5000 gram, especially 500-5000 gram of carbon per m² on the soil. Especially, at least 50, such as at least 100, even more especially at least 250, such as at least 500 grams of carbon is provided on the soil in the deposition stage. Further, especially, a maximum of 5000 grams, such as a maximum of 3000 grams, even more especially a maximum of 2000 grams of carbon is provided on the soil in the deposition stage.

In order to provide or create an anaerobic condition in the soil that is advantageous for weed control, a barrier layer may be applied between the soil and the air after the application of the product described above. The barrier layer is especially provided on the soil (with the product provided thereon). The barrier layer is provided (or applied) in the barrier layer stage. The terms “application of a barrier layer between the soil and the air” and “providing a barrier layer on the soil (with the product provided thereon)” cover various options and denote in particular the placement of a barrier layer on the ground, i.e. generally at least partly in contact with the soil/ground. They also include cases wherein the barrier layer (only) contacts the product. The use of the word “on” in the phrase “providing a barrier layer on the soil” includes embodiments wherein further elements may be present between the barrier layer and the soil, wherein the barrier layer does not directly contact the soil. The barrier layer may e.g. contact remainders of weeds (roots and/or parts of the stems, etc., especially extending from the ground) that were mown or cut before applying the product (see further below). The barrier layer essentially has a very low oxygen permeability (transmission) (see below). The barrier layer is especially substantially not permeable for oxygen. Especially the barrier layer is configured to provide a substantially oxygen-free environment in the soil (see also below).

In embodiments, the barrier layer is made of a plastic. The term “plastic” also covers film materials here. The plastics and films that can be used to apply a barrier layer between the soil and the air are exemplified nylon, multi-ply barrier film (such as Hytibarrier film), biodegradable film and plastics, as well as spray-on plastics or other spray-on film-forming products.

The term “oxygen-free state” especially relates to anaerobic conditions.

The barrier layer used may in embodiments be essentially impervious to oxygen. The barrier layer is arranged in particular to create substantially anaerobic conditions in the soil under it. The amount of the product and the nature of the barrier layer may in embodiments be selected such that—in the course of preferably at least a number of days, such as at least 5 days or at least 15 days—the oxygen content of the air in the soil under the barrier layer is of the order of magnitude of at most 2 vol % and especially at most 1 vol %, such as at most 0.5 vol %. In embodiments, the oxygen content can drop below about 2 vol % about 1 to 3 days after deposition and coverage. The oxygen content may further decrease to less than 1% in the next 1 to 2 days. The anaerobic conditions may last for at least 6 consecutive weeks, especially for at least 2 months such as at least 4 months or at least a year.

In one of the embodiments, the barrier layer used has an oxygen transmission rate (OTR) of at most 2000 ml of oxygen per square meter per hour, i.e. an OTR value of at most 2000 ml/m²/h. In a specific embodiment, the OTR value is at most 1500 ml/m²/h. The barrier layer may in further embodiments be selected for having an oxygen transmission rate (OTR) value equal to or lower than 1000 ml of oxygen per m² per hour.

A plastic film is used in embodiments as the barrier layer. It was further found that also organic materials, such as fresh (un-processed) organic material may provide an oxygen barrier. For instance, a layer of (grass) silage, a layer of mown grass, or a layer of mown weeds may provide an oxygen barrier. In specific embodiments, the barrier layer may (further) comprise one or more of (grass) silage, mown grass, and mown weeds. Moreover, the barrier layer may comprise a layer comprising, especially substantially consisting of, (grass) silage, mown grass, or mown weeds, or combinations thereof. The barrier layer may comprise a layer comprising, especially substantially consisting of, mown grass and (mown) weeds. The grass may comprise weeds.

It is noted that in embodiments the (mown) weeds applied in the barrier layer may differ from the weeds that are controlled by the method. Alternatively, in embodiments, at least part of the (mown) weeds applied in the barrier layer may correspond to the weeds that are controlled by the method. In embodiments, e.g., aerial parts of the weeds are removed before providing the product on the soil and successively these removed parts are applied in the barrier layer, see further below.

The term “layer” may in embodiments refer to a plurality of (different) layers. The barrier layer may for instance comprise two different layers in embodiments, whereas it may comprise three, or four, or even more (different or the same) layers in further embodiments. The different layers may be stacked on top of each other.

In specific embodiments, the barrier layer may comprise a first (barrier) layer of unprocessed organic material (for instance comprising silage) in combination with a second (barrier) layer of gravel or e.g. sand. In such barrier layer, initially the first barrier layer may be provided in the barrier layer stage and next the second layer may be provided on top of the first layer (in the barrier layer stage) and compacting the first layer, especially resulting in a reduced oxygen permeability. The second barrier layer and/or any barrier layer may especially comprise a granular solid material. The barrier layer may, in embodiments, comprise a layer comprising sand or pebbles. The barrier layer may further comprise a layer comprising a solid material layer.

The barrier layer may in specific embodiments comprise a solid material layer comprising the granular solid material. In further embodiments the solid material layer has an average layer height equal to or higher than 2 cm, especially equal to or higher than 5 cm, such as equal to or higher than 10 cm, even more especially of at least 25 cm. The average layer height (of the solid material layer) may further be 75 cm at maximum, such as 50 cm at maximum, even more especially 30 cm at maximum. The average layer height may especially be selected from the range of 5-70 cm, especially from the range of 5-50 cm, even more especially selected from the range of 15-50 cm. The solid layer may not be completely levelled out (depending on how it is applied on the ground). Therefore, the layer height is especially given as an average value. In embodiments at least 50%, such as at least 80% of the solid layer comprises a layer height that may be within a range of the 75% of the average height value to 125% times of the average height. The granular solid material may in embodiments be configured for compressing a further layer under the granular material and/or for maintaining a humidity in material under the granular solid material. A minimum local height of the solid material layer may especially be at least 2 cm, especially at least 5 cm, and in embodiments at least 10 cm.

Under certain conditions, it may be possible to create a barrier layer between the soil and the air by providing a granular solid material on top of the soil, and rolling the granular solid material or driving over it in order to compress or compact it and therefore seal it. In embodiments, the barrier layer stage may further comprise compacting the barrier layer successive to providing the barrier layer on the soil.

Another possible alternative for the application of a barrier layer is sealing the soil with water. According to one of the advantageous embodiments of the present invention, (at least part of) the barrier layer is applied by inundation. The barrier layer may in embodiments comprise water.

Hence, in specific embodiments, the barrier layer comprises one or more layers comprising, substantially consisting of, (grass) silage, mown grass, mown weeds, mown grass and weeds, granular solid material, water, plastic foil, and a spray-on film-forming material. The granular solid material may in embodiments comprise one or more of sand, soil, gravel, and pebbles. The granular solid material may further comprise chippings and/or aggregates.

In specific embodiments, the barrier layer comprises a solid material layer comprising the granular solid material, wherein the solid material layer has an average layer height selected from the range of 5-50 cm, and especially wherein the granular solid material comprises one or more of sand, soil, gravel, and pebbles.

Further, especially, the barrier layer comprises a first barrier layer and a second barrier layer, wherein in the barrier layer stage (i) first the first barrier layer is deposited on the soil with the product provided thereon, and (ii) subsequently the second barrier layer is provided on the first barrier layer. In embodiments, the first barrier layer comprises one or more of the (grass) silage, mown grass, mown weeds, water, plastic foil, and spray-on film-forming material. Further, especially, the second barrier layer comprises the granular solid material.

Further, in embodiments, the barrier layer stage comprises providing at least part of the barrier layer by inundation.

The barrier layer may in embodiments be left on the soil for at least 30 days, especially at least 6 weeks, such as at least two months, especially at least four months, even more especially at least 6 months (after providing the barrier layer on the soil). Depending on the configuration the barrier layer is removed after the holding period. For instance, a plastic foil comprising barrier layer is preferably removed after the desired holding period. The holding period may further be selected based on a temperature of the soil. Preferably, the average temperature of the soil is at least 10° C., such as at least 15° C. (during the day) during the holding period. The holding period of a first embodiment may be selected to be longer than the holding period of a second embodiment (based on the same deposition stage and using the same barrier layer) if the (average) temperature of the soil (during the day) in the first embodiment is lower than in the second embodiment. For instance, an increase in average temperature of the soil with 10° C. (during the same holding period) may in embodiments provide comparable results as an increase of 20-40% in the holding period (at the same average temperature).

In other embodiments, the barrier layer may be left in the soil. For instance, a barrier layer consisting of organic material as described herein may be left on the soil after the holding period. In embodiments, the barrier layer is digested by nature on or in the soil. The holding period may essentially be indefinitely long. For practical reasons, the holding period may in embodiments be ultimately 24 months, such as ultimately 12 months, such as ultimately 8 months, especially ultimately 6 months, or in embodiments ultimately 3 months. The holding period is in embodiments 30 days—12 months, such as 6 weeks to 12 months, especially 3 to 9 months, such as 6 to 9 months. During this holding period, the oxygen content in the soil covered by the product and the barrier layer may decrease. The oxygen content may especially decrease based on a digestion of the product by soil life, The holding period especially results in an anaerobic condition of the soil. Hence, in embodiments, the method comprises after providing the barrier layer on the soil, leaving the barrier layer for a holding period, such as at 6 weeks, on the soil, especially leaving the barrier layer for at least 6 months on the soil.

Further, the barrier layer may be provided on the soil within a couple of day. The barrier layer is provided especially (almost) directly after depositing the processed organic material on the soil.

It may be advantageous if the soil comprises a moisture content of at least 10 wt %, such as at least 15 wt %, especially at least 20 wt %. Such moisture content is rather a common moisture content of soil (to be treated). Yet, in embodiments, the method may comprise wetting the soil before providing the barrier layer to provide a moisture content of at least 10 wt %, such as at least 15 wt %, especially at least 20 wt % to the soil, for instance to a top layer (of at least 10 cm) of the soil.

In a further specific embodiment of the method, the product comprises a particulate product, the product comprises one or more of (i) at least 10 wt % of protein, (ii) at least 15 wt % carbohydrate, and (iii) at least 10 wt % of lipids, especially at least 10 wt % of protein, (all) calculated on a dry-matter basis. Further, especially, the deposition stage comprises providing the product in an amount of at least 250, especially at least 500 gram/m² on the soil. In yet further embodiments, the barrier layer stage comprises (i) providing a first barrier layer of one or more of silage, mown grass, and mown weeds in an amount of 5 to 15 kg/m² on the soil (with the product); and (ii) providing a second barrier layer on the first barrier layer, especially wherein the second barrier layer comprises granular solid material, to provide the barrier layer on the soil. Additionally, or alternatively, the second barrier layer may comprise one or more of water, plastic foil, and (a) spray-on film-forming material. In further embodiments, the barrier layer providing stage may further comprise providing one or more further barrier layers on the second barrier layer (or any respective further barrier layer if more than one further barrier layers are provided). The further barrier layer may comprise any of the materials described herein in relation to the barrier layer.

In embodiments, the product is (directly) provided on the soil comprising the weeds. In further embodiments, first aerial parts of the weeds are removed and especially, the product is provided on the soil comprising remaining parts of the weeds (i.e. the parts of the weeds that are not removed such as the roots and for instance part of the stems and the leaves). The aerial parts of the weeds may in embodiments be removed in a weeding stage. In embodiments, the removed aerial parts of the weeds may (especially after chopping or any other size reducing action) in embodiments be used (as a layer) in the barrier layer.

Hence, in embodiments, the method further comprising a weeds removing stage prior to the deposition stage. The weeds removing stage especially comprises weeding (e.g. cutting and/or mowing) the weeds hosted by the soil (especially resulting in cut parts comprising the aerial parts, and roots that remain in the soil) and removing cut parts of the weeds from the soil. In further specific embodiments, the deposition stage comprises providing the product on the soil comprising remaining parts (especially at least roots) of the weeds.

The term “cut parts” especially refers to aerial parts that are removed. In yet further embodiments, the barrier layer comprising stage may comprise providing (at least part of) the cuts parts on the soil (directly or on another layer of the barrier layer). In embodiments, the cut parts are chopped before providing them on the soil. One of the barrier layers may (thus) comprise the cut parts.

The term “chopped” in “chopping the cut parts” and comparable phrases refers to further reducing the cut parts in size (by dividing the cut parts in smaller parts). It will be understood that chopping also includes grinding, cutting, etc.

Hence, the invention also provides for use of the method for biological weed control, especially for control of knot weeds described herein.

### BRIEF DESCRIPTION OF THE DRAWINGS

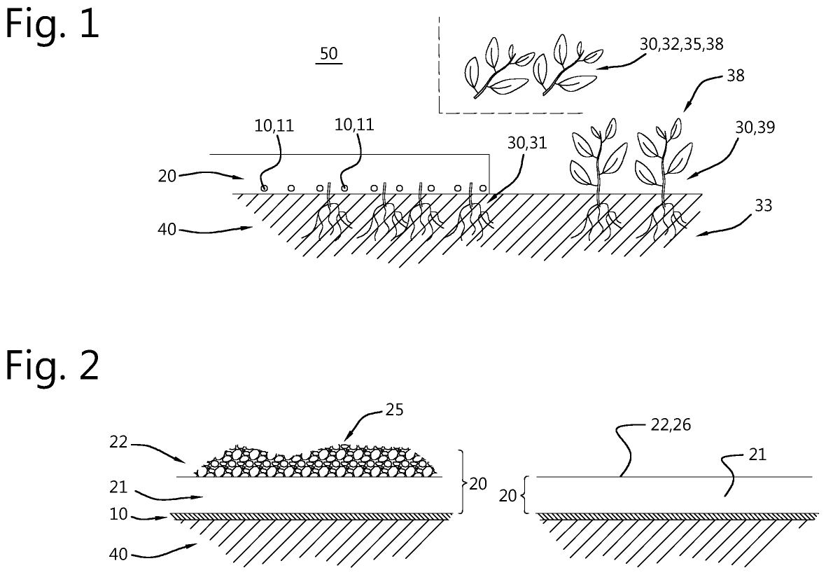

Embodiments of the invention will now be described, by way of example only, with reference to the accompanying schematic drawings in which corresponding reference symbols indicate corresponding parts, and in which FIG. 1 schematically depicts some aspects of the invention and FIG. 2 depicts some aspects of the barrier layer. The schematic drawings are not necessarily to scale.

### DETAILED DESCRIPTION OF THE EMBODIMENTS

FIG. 1 schematically depicts aspects of the method of the invention. The method is used for weed control, especially to control, especially to (substantially) eradicate, weeds 30 growing in soil 40 (or “hosted by the soil” 40). Herein, the term weeds 30 is used for entire plants 39. The term is also used to refer to parts of the weeds 30, e.g., obtained after cutting or mowing the weeds 30. The term may, e.g., refer to cut parts 32 of weeds 30, especially comprising the aerial parts 38 of the weeds 30, as well as the remainders 31 of the weeds 30, comprising the roots 33 of the weeds 30. The term “mown weeds” 35 especially refers to the aerial part 38 of the weeds 30 that are cut from the remainders 31 of the weed 30 comprising the roots 33. The weeds 30 that may be controlled, especially eradicated, by the method are especially knotweeds, more especially various Asian knotweed types described herein. The weeds 30 that may be controlled may further (also) comprise other invasive weeds described above, for example Giant hogweed.

The method comprises a deposition stage followed by a barrier layer stage. In the deposition stage a product 10 is provided on the soil 40 (comprising the weeds 30, especially the roots 33 of the weeds 30). In the barrier layer stage, a barrier layer 20 is provided on the soil 40 with the product 10 provided thereon. The product 10 comprises processed organic material 11 and is especially not actively mixed with the soil 40 after providing, such as sprinkling, it on top of the soil 40. In embodiments, the product 10 comprises a particular product 10 as is schematically depicted in FIG. 1.

The function of the barrier layer 20 is to slow down or inhibit an oxygen transport from the air 50 to the soil 40. The barrier layer 20 is especially an oxygen barrier layer 20. The barrier layer 20 may for instance have an oxygen transmission rate “OTR” value equal to or lower than 2000 ml of oxygen per m² per hour or equal to or lower than 1000 ml of oxygen per m² per hour. To accomplish the reduced oxygen permeability the barrier layer 20 may comprise one layer or a plurality of layers. A layer may consist of (grass) silage, or mown grass, or mown weeds 35, or a mixture thereof. Further, one or more of the layers may consist of granular solid material 25, water, plastic foil, and a spray-on film-forming material. The granular solid material 25 may especially comprise sand and/or soil and/or gravel and/or pebbles.

In embodiments, the barrier layer 20 comprises a solid material layer of 10-50 cm average height, especially 15-50 cm average height, comprising the granular solid material 25. In further embodiments, the barrier layer 20 comprises a first barrier layer 21 and a second barrier layer 22. Therefore, the barrier layer stage may comprise first depositing the first barrier layer 21 on the soil 40 (with the product 10 provided thereon), and consecutively providing the second barrier layer 22 on the first barrier layer 21, schematically indicated in FIG. 2. In such embodiment especially the first barrier layer 21 may comprise unprocessed organic material such as silage, mown grass, or mown weeds 35. The second barrier layer 22 especially comprises one or more of the granular solid material 25, water, plastic foil, and a spray-on film-forming material. In further embodiments, the (first) barrier layer 20, 21 may comprise one or more of water, plastic foil, and a spray-on film-forming material. The second barrier (if present) may especially comprise the granular solid material 25. In yet further embodiments, the barrier layer comprises three (barrier) layers, or even more (barrier) layers. Hence, also a third barrier layer may be deposited on the second barrier layer 22, a fourth barrier layer may be provided on the third barrier layer, etc. The barrier layer 20 may in specific embodiments comprise water. At least part of the barrier layer 20 may be provided by inundation.

The mown weeds 35 applied in the barrier layer 20, not necessarily comprise cut parts 32 of the weeds 30 that are controlled by the method. However, in advantageous embodiments, the method comprising a weeds removing stage prior to the deposition stage. In the weeds removing stage, the weeds 30 growing in the soil 40 are weed (cut and/or mown) and the cut parts 32 of the weeds 30 are removed from the soil 40 (schematically these cut parts 32 are indicated in the insert in FIG. 1). Successively, the cuts parts 32 of the weeds 30 may be applied in the barrier layer 20. In time, these cut parts 32 may disintegrate, which may further facilitate the reduction in oxygen in the soil 40.

Hence, in embodiments the product 10 is provided on the soil 40 comprising remaining parts 31 (also indicated as roots 33) of the weeds 30 (see FIG. 1), in the deposition stage.

After providing the barrier layer 20 on the soil 40, the barrier layer 20 may be left on the soil 40 for a prolonged period. The prolonged period may at least be thirty days, such as at least six weeks, or at least six months. In embodiments the prolonged period is one to six months, even more especially one to twelve months.

The product used in the method comprises organic material, more especially processed organic material 11. The processed organic material 11 comprises one or more materials selected from the group consisting of proteins, carbohydrates, and lipids. The processed organic material 11 may for instance be obtained by processing (i) plants or plant material, (ii) animals or animal material, or (iii) parts thereof. Alternatively, or additionally, the processed organic material 11 may be obtained by processing (parts of) animals. The processed organic material 11 may for instance comprise a by-product of an industrial process, e.g. from a side stream arising from a plant processing operation or an animal processing operation. The processed organic material 11 may further comprise (further) processed material, especially a by-product, of an agricultural operation. Such further processed material may e.g. comprise agricultural or horticultural waste material (or “by products”) including stems and/or leaves, that are dried in a (controlled) drying process.

The product 10 essentially comprises carbon. Herein “carbon” refers to carbon atoms in molecules of the organic material 11. Carbon atoms are for instance present in (carbon) backbone of carbohydrates, lipids, and proteins. If reference is made to a (total) weight of carbon in an element (such as in the product), this especially refers to a total weight of the carbon atoms in the element (product). Carbon may also be present in side chains, etc. In embodiments, the product 10 comprises at least 30 grams of carbon per 100 gram of product 10, such as at least 50 grams carbon per 100 gram product 10 (calculated on a dry-matter basis). Further, the product 10 may especially comprise at least 10 wt % of protein, calculated on a dry-matter basis.

Using the method, the product 10 may especially provide the processed organic material 11 in an amount of at least 500 gram per m² on the soil 40 (by providing the product on the soil 40 in the deposition stage). Especially, the product 10 may provide 100-500 gram of protein per m² on the soil 40. In embodiments, at least 100 grams of carbon per m² soil is provided in the deposition stage (by providing the product 10 on the soil 40). In specific embodiments, the product 10 provides 100-500 gram of carbon per m² on the soil 40.

### Experimental

Preliminary tests were conducted with the method. In the experiments 10-liter buckets were filled with 8 liters of soil (taken from the forest). In the soil, pieces of Japanese knotweed root. In a first bucket, 80 gram of the product (agricultural by-product with approx. 27 wt % protein) was provided on top of the soil. In a second bucket no product was added to the soil (negative control/no treatment) and in a third bucket 80 grams of the product was mixed with the soil (comparable to anaerobic soil disinfestation method) The buckets were sealed with a lid and opened again after a holding period of over 4 weeks.

The four-week holding period in combination with the amount of product did not entire kill the roots yet. It was observed that the roots from the second bucket (untreated) started to sprout again after a few days. The roots from the first and third bucket started to sprout in a much lesser extent, and only after a couple of weeks. Comparable results were obtained with the first bucket (only providing the product at the surface of the soil) and the third bucket (wherein the product was mixed with the soil). The results show that mixing the product with the soil is not required for treating the weeds. This is also experimentally shown with larger initial tests on the land, where the method was tested using a holding period of over three months.

Further analysis of the soil in the buckets was performed by phospholipid fatty acids analysis This revealed that the number of bacteria and protozoa did not change much between the first bucket (product provided on top of the soil) and the second bucket (no treatment), while the number of bacteria and protozoa had increased sharply in the third bucket (product mixed in the soil):
Total bacteria (no unit; based on mg phospholipid fatty acid associated with the bacteria/ml soil): no treatment: 6, product on the soil: 4.9, product mixed in the soil BR: 9
Protozoa (no unit; based on mg phospholipid fatty acid associated with the protozoa/ml soil): no treatment: <0.06, product on the soil: <0.06, product mixed in the soil: 0.2

Based on the experiment it was concluded that providing the product on the soil provides the same effect on the weeds as mixing the product in the soil. The latter is a common method for soil disinfestation (to kill pathogenic nematodes/fungi). The soil disinfestation is caused by the bacteria and protozoa development. The analysis shows that not mixing the product with the soil does not result in the desired development of bacteria and protozoa indicating that mixing the product with the soil is a requirement for ASD, whereas it surprisingly is not required for weed control.

The term “plurality” refers to two or more. Furthermore, the terms “a plurality of” and “a number of” may be used interchangeably.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%. Moreover, the terms “about” and “approximately” may also relate to 90% or higher, such as 95% or higher, especially 99% or higher, even more especially 99.5% or higher, including 100%. For numerical values it is to be understood that the terms “substantially”, “essentially”, “about”, and “approximately” may also relate to the range of 90%-110%, such as 95%-105%, especially 99%-101% of the values(s) it refers to.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Further the term “one or more” may in embodiments refer to two or more, three or more, etc. For instance in a phrase “one or more items selected from the group consisting of item 1, item two, item 3, . . . , and item n” and similar phrases may relate to one or more items selected from the group consisting of item 1, item 2, item 3, . . . , and item n, two or more items selected from the group consisting of item 1, item two, item 3, . . . , and item n, three or more items selected from the group consisting of item 1, item two, item 3, . . . , and item n, . . . , up to n−1 or more (i.e. n) items selected from the group consisting of item 1, item two, item 3, . . . , and item n.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

The term “further embodiment” and similar terms may refer to an embodiment comprising the features of the previously discussed embodiment but may also refer to an alternative embodiment.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, “include”, “including”, “contain”, “containing” and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings. Moreover, if a method or an embodiment of the method is described being executed in a device, apparatus, or system, it will be understood that the device, apparatus, or system is suitable for or configured for (executing) the method or the embodiment of the method, respectively.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1.-15. (canceled)

16. A method for weed control, comprising:
a deposition stage; and
a barrier layer stage subsequent to the deposition stage;
the deposition stage comprising:
providing a product comprising processed organic material on soil and leaving the product on the soil, wherein the soil hosts weeds, wherein the weeds comprise one or more of Giant hogweed and Asian knotweed, wherein the processed organic material comprises one or more materials selected from the group consisting of proteins, carbohydrates, and lipids, wherein the processed organic material comprises at least 35 wt. % rapidly degradable organic material, wherein at least 100 grams of carbon per m² soil is provided by the product on the soil, and wherein at least 500 gram of rapidly degradable organic material is provided per m² on the soil; and wherein the for the rapidly degradable organic material applies that:
if the rapidly degradable organic material is mixed in the soil (40) and maintained in the soil under standard conditions of 20° C. and 10%-25% moisture, then at least 90 wt % of the processed organic material is degraded by micro-organism in the soil within three month;
the barrier layer stage comprising:
providing an oxygen barrier layer on the soil with the product provided thereon and leaving the barrier layer on the soil for at least 4 months, wherein the oxygen barrier layer has an oxygen transmission rate (OTR) value equal to or lower than 1000 ml of oxygen per m2 per hour;
wherein the product is not actively mixed in the soil prior to providing the oxygen barrier on the soil.

17. The method according to claim 16, wherein no more than 2500 gram of rapidly degradable organic material is provided per m2 soil in the deposition stage.

18. The method according to claim 16, wherein the processed organic material is obtained by processing (i) plants, (ii) animals, or (iii) parts thereof.

19. The method according to claim 16, wherein the processed organic material comprises one or more of (i) a by-product originating from an industrial process for processing organic material and a further processed organic material originating from an agricultural operation.

20. The method according to claim 16, wherein on a dry matter basis at least 95 wt % of the product (10) consists of one or more of (i) proteins, (ii) carbohydrates, and (iii) lipids.

21. The method according to claim 16, wherein the product comprises an amount of protein selected from a range of 15-40 wt %, an amount of lipid selected from a range of 2-15 wt %, an amount of sugar selected from a range of 2-10 wt %, and an amount of starch selected from a range of 1-5 wt %.

22. The method according to claim 16, wherein the product comprises a particulate product.

23. The method according to claim 16, wherein the barrier layer comprises one or more layers consisting of one or more of grass silage, mown grass, mown weeds, plastic foil, spray-on film-forming material, and granular solid material comprising one or more of sand, soil, gravel, and pebbles.

24. The method according to claim 23, wherein the barrier layer comprises a solid material layer comprising the granular solid material, wherein the solid material layer has an average layer height selected from the range of 5-50 cm.

25. The method according to claim 23, wherein the barrier layer comprises a first barrier layer and a second barrier layer, wherein in the barrier layer stage (i) first the first barrier layer is deposited on the soil with the product provided thereon, and (ii) subsequently the second barrier layer is provided on the first barrier layer, wherein the first barrier layer comprises one or more of the grass silage, the mown grass, the mown weeds, the plastic foil, and the spray-on film-forming material, and the second barrier layer comprises the granular solid material.

26. The method according to claim 16, further comprising a weeds removing stage prior to the deposition stage, wherein the weeds removing stage comprises weeding the weeds hosted by the soil thereby providing cut parts of the weeds comprising areal parts of the weeds, wherein roots remain in the soil, and removing cut parts of the weeds from the soil.

27. The method according to claim 16, wherein the Asian knotweed comprises one or more knotweeds selected from the group consisting of Japanese knotweed, Sachalin knotweed, and Bohemian knotweed.
